(19) United States
(12) Patent Application Publication
(10) Pub. No.: US 2013/0158189 A1
(43) Pub. Date: Jun. 20, 2013

(54) Method for Polymer Plasma Deposition

(71) Applicants: Francois Reniers, Bruxelles (BE); Julie Hubert, Bruxelles (BE)

(72) Inventors: Francois Reniers, Bruxelles (BE); Julie Hubert, Bruxelles (BE)

(21) Appl. No.: 13/809,309

(22) PCT Filed: Jul. 12, 2011
(86) PCT No.: PCT/EP11/61864

§ 371 Date: Mar. 7, 2013

Related U.S. Application Data
(60) Provisional application No. 61/363,464, filed on Jul. 12, 2010.
(60) Provisional application No. 61/363,477, filed on Jul. 12, 2010.

(30) Foreign Application Priority Data
Nov. 12, 2010 (EP) 10191082.6

(51) Int. Cl. B05D 1/00; C09D 127/04

(52) U.S. Cl. CPC B05D 1/62; C09D 127/04
USPC 524/551; 427/569; 427/575

(57) ABSTRACT

The present invention is related to a method or the deposition of a chlorinated polymeric layer onto a ubstrate, said method comprising the steps of:—generating a plasma in a gaseous medium by means of a plasma device;—placing the substrate in contact with the plasma, or in the post-plasma area;—introducing in said plasma or in the post-plasma area a chlorinated precursor of the chlorinated polymer.

### FIELD OF THE INVENTION

The present invention is related to a method for the deposition of a chlorinated polymer layer.

The present invention is also related to a substrate comprising a cross-linked chlorinated polymer layer.

### TECHNOLOGICAL BACKGROUND

The conventional methods of polymerisation often require the addition of solvents, catalysts, initiators and inhibitors of reaction. Other ways of synthesis, having smaller environmental impact can be envisaged. For several years, polymers have been obtained by vacuum plasma polymerisation. It is the case for example of polystyrene or polypyrrole.

In the case of chlorinated polymers, the processing by conventional methods such as extrusion or coextrusion is further complicated by the thermal sensitivity of the C—Cl bond. At extrusion temperature, these bonds tend to break, Cl being emitted. For that reason, large amounts of acid scavengers are used in the polymer composition to neutralise HCl. This phenomenon is particularily true for PVDC. As a consequence, PVDC coating are usually performed by solvent coating by either monophasic or emulsion (latex) liquids.

The plasma polymerisation represents, in certain cases, an interesting alternative to the conventional methods, for both the technical aspects and the properties of the synthesized polymers. Indeed, this low-temperature process, without solvents, has smaller environmental impact and often requires fewer steps than most of the existing industrial processes (mainly for complex polymers).

Furthermore, the properties of polymers synthesized by plasma polymerisation differ from their conventional analogues in the fact that they are produced by recombination of radical fragments generated by high energy particles resulting from the plasma. As a consequence, they are not constituted, of regularly repeated units but tend to form cross linked and less ordered (amorphous) polymers.

The cross linked character of these coatings (layers) improves both their thermal stability (infusible) and their solvent resistance (insoluble).

The plasma polymerisation process also allows easy and convenient production of polymer layers having low thicknesses (50 nm to 1 μm), which is difficult for conventional processes such as extrusion.

The plasmas deposition processes also allow the control of polymerisation parameters allowing the manufacturing of polymeric layers with particular chemical functions, and thicknesses, bringing specific chemical and physical properties.

More recently, plasma deposited layer were obtained by atmospheric plasma polymerisation processes, allowing to reduce the constraints associated with the vacuum technology (pumping devices, degassing, etc.). In that context, the use of dielectric barrier discharges DBD seems to be particularly simple and effective.

As a way of example, layers of polyacrylic acid have been produced by plasma polymerisation at atmospheric pressure. Examples of such deposition processes can be found in the following documents:
M. Tatoulian, F. A. Arefi-Khonsari, J-P. Borra, Plasma Processes and Polymers, 4, 2007, pp 360-369;
L. J. Ward, W. C. E. Schofield, and J. P. S. Badyal, Chemistry of Materials., 15, 2003, 1466-1469;
I. Topala, N. Dumitrascu, G. Popa, Nuclear Instruments and Methods in Physics Research B, 267, 2009, pp 442-445. 14,15,16.

Atmospheric plasma are known (and used) to degrade chlorinated organic compounds rather than to polymerize them. Example of such decomposition process can be found in the following documents:
R. Rudolph, K.-P. Francke, and H. Miessner, Concentration Dependence of VOC Decomposition by Dielectric Barrier Discharges, Plasma Chemistry and Plasma Processing, Vol. 22, No. 3, September 2002;
Ester Marotta, Gianfranco Scorrano, Cristina Paradisi, Ionic Reactions of Chlorinated Volatile Organic Compounds in Air Plasma at Atmospheric Pressure, Plasma Process. Polym. 2005, 2, 209-217;
S. A. Vitale, K. Hadidi, D. R. Cohn, and L. Bromberg, Decomposition of 1,1-Dichloroethane and 1,1-Dichloroethene in an electron beam generated plasma reactor, J. Appl. Phys. 81 (6), 15 Mar. 1997;
US 2007/172602.

From the literature, there is no significant data related to the plasma polymerisation of a chlorinated organic polymer starting from a simple chlorinated organic precursor at a pressure close to atmospheric pressure.

Document GB 1140502 discloses a plasma polymerisation process wherein the substrate is maintained at a temperature below the condensation temperature of the polymer precursor. In that process, most of the precursor condenses on the substrate without being activated by the plasma, only few precursor molecules being activated in the form of reactive radicals, those radicals acting as initiators of the polymerisation occurring in the condensed phase. Therefore, as propagation reaction in radicalar polymerisation is mostly limited to C=C double bond, the disclosed method is limited to precursor comprising such double bonds.

### AIMS OF THE INVENTION

The present invention aims to provide a process for the deposition of a chlorinated polymer layer that does not present the drawbacks of prior art deposition processes.

More particularly, the present invention aims to provide a chlorinated polymer deposition process which does not require the use of solvents.

Other advantages of the method according to the invention will be apparent from the following description.

### SUMMARY OF THE INVENTION

The present invention relates to a method for the deposition on a substrate of a chlorinated polymeric layer, said method comprising the steps of:
generating a plasma in a gaseous medium by means of a plasma device;
placing the substrate in contact with the plasma, or in the post-plasma (post-discharge) area;
introducing in said plasma or in the post-plasma area a precursor of the chlorinated polymer, said precursor comprising (or consisting essentially or consisting of) a chlorinated organic compound,
characterised in that the oxygen partial pressure in the plasma device is maintained below 10 hPa, preferably below 5 hPa.

Another aspect of the invention is related to a method for producing an article comprising a substrate and a chlorinated polymeric layer deposited on the substrate, said method comprising the step of exposing the substrate to a plasma generated in a gaseous medium said gaseous medium comprising at least one chlorinated precursor of the chlorinated polymer, said plasma being generated by means of a plasma device comprising a discharge area.

According to particular preferred embodiments, the methods of the present invention comprises one or a suitable combination of at least two of the following features:
the precursor partial pressure in the plasma device is lower than or equal to the saturation vapour pressure of the precursor at the substrate temperature;
the precursor comprises, consists essentially of or consists of a chlorinated organic compound having a Cl/C ratio higher than 0.25, preferably higher than 0.5, advantageously higher than or equal to 1;
said precursor comprises, consists essentially of or consists of a polychlorinated organic compound selected from the group consisting of polychloroalkane, polychloroalkene, polychloroalkyne, polychloroarene, tertiary amine comprising perchloroalkanes groups and mixture thereof, preferably, said polychlorinated organic compound is a perchlorinated organic compound;
said precursor comprises, consists essentially of or consists of hexachlorobuta-1,3-diene;
said precursor comprises, consists essentially of or consists of tetrachloroethane (C₂H₂Cl₄);
said precursor comprises, consists essentially of or consists of molecules having the following structure:

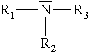

wherein R₁, R₂ et R₃ are perchloroalkane groups, having a formula of the type CₙCl₂ₙ₊₁;
said precursor is free of oxygen atoms;
the pressure in the plasma reactor is comprised between 100 hPa and 2000 hPa, preferably between 400 hPa and 1200 hPa, more preferably between 500 and 600 hPa;
the temperature of ionic and neutral species in the plasma is below 400° C., preferably below 150° C.;
the plasma is a dielectric barrier discharge (DBD) plasma, a radiofrequency plasma, a DC pulsed plasma, a microwave plasma or an electron cyclotron resonance (ECR) discharge plasmas;
the plasma is a DBD operating at frequencies between 1 and 500 kHZ, in the alternate mode or in the (pulsed) continuous mode;
the gaseous medium further comprises a plasma generating gas, such as argon, helium, neon, xenon, nitrogen or mixture thereof preferably argon;
chlorinated gas, such as Cl₂, is injected in the gaseous medium;
the precursor further comprises fluorine atoms.

Another aspect of the invention is related to an article comprising a substrate and a chlorinated polymeric layer producible by the method of the invention.

According to particular preferred embodiments, the article of the invention comprises one or a suitable combination of at least two of the following features:
said polymeric layer is cross-linked;
said polymeric layer comprises, consists essentially of or consists of a polymer selected from the group consisting of PVC, PVDC, polychloropropene, Poly(chloro-p-xylene), Poly(chlorotrifluoroethylene), Poly(vinyl chloroacetate), Poly(2-chlorostyrene) and mixture thereof;
the polymeric layer is a chlorinated polymer having a Cl/C ratio higher than 0.1, preferably higher than 0.25, more preferably higher than or equal to 0.5;
the Cl/C ratio of the polymeric layer is higher than 0.75;
the Cl/C ratio of the polymeric layer is higher than or equal to 1;
the polymeric layer is a chlorinated polymer having a Cl/C ratio comprised between 0.9 and 1.1.
said polymeric layer has properties close to the properties of PVDC, more specifically, gas barrier properties.

### BRIEF DESCRIPTION OF THE DRAWINGS

FIG. 1 represents an example of experimental setup for carrying out the process of the present invention, as used in the example.

FIG. 2 represents an example of experimental setup for carrying out the process of the present invention, wherein the substrate is in a post-plasma (post-discharge) area.

FIG. 3 represents an example of experimental setup for carrying out the process of the present invention, wherein the substrate is in a post-plasma (post-discharge) area, and the precursor is also injected in the post-discharge area.

FIG. 4 represents an example of experimental setup for carrying out the process of the present invention, wherein the substrate is in a post-plasma of an RF plasma located between two grids.

FIG. 5 represents a full survey XPS spectrum of a coating according to an example 1 of the invention.

FIG. 6 represents a full survey XPS spectrum of a coating according to an example 2 of the invention.

FIG. 7 represents a full survey XPS spectrum of a coating according to an example 3 of the invention.

### DETAILED DESCRIPTION OF THE INVENTION

The present invention discloses a deposition process wherein a chlorinated polymeric layer is deposited by a plasma process.

By polymeric layer or polymer coating, it is meant in the present document a layer comprising a polymeric matrix, comprising eventually additional non polymeric phases.

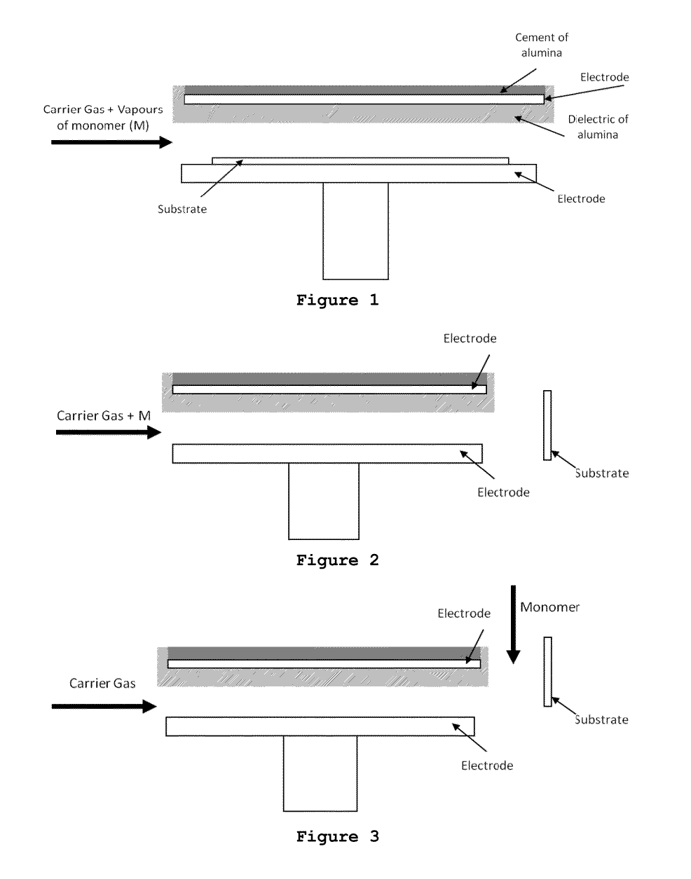

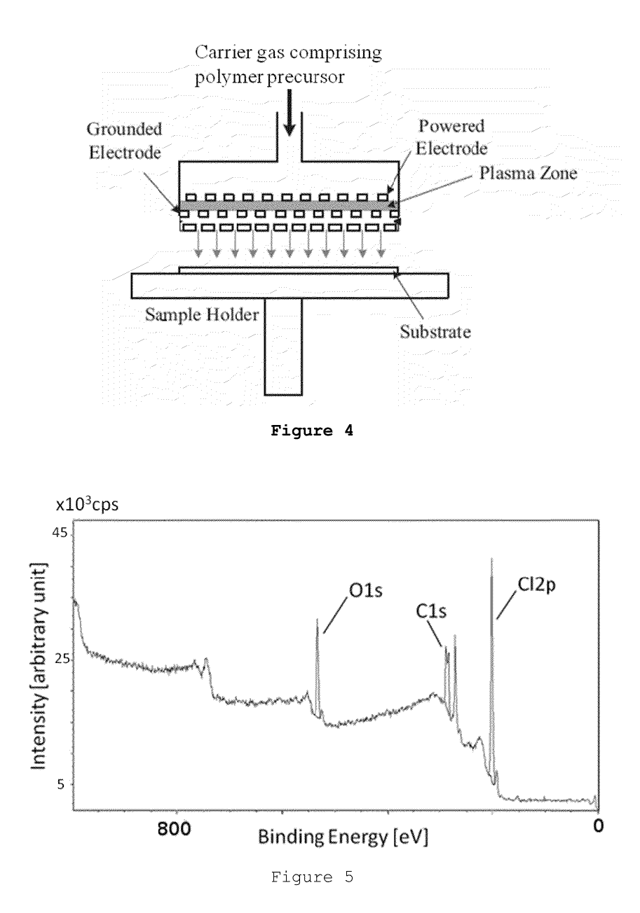

To this aim, a chlorinated organic compound precursor of the polymer (monomer)is injected in a plasma (or in post plasma zone) in the vicinity of a substrate to be coated. The substrate itself can be either in contact of the plasma, or in the post-plasma zone. FIG. 1 represents an example wherein the substrate is in the plasma area.

In order to avoid the condensation of unactivated monomer on the substrate surface, it is preferred to maintain the substrate at a temperature above or equal to the condensation temperature of the monomer.

This means that preferably, the monomer partial pressure in the plasma reactor is maintained at a value below or equal to the monomer saturation pressure at the substrate temperature. This parameter also ensure better adhesion of the coating layer, as only reactive species (plasma activated) condenses on the surface of the substrate at least in the early stage of the deposition process.

Preferably, the substrate temperature is above the condensation temperature of the unactivated monomer.

The present invention also relates to a method for depositing a chlorinated layer on a substrate, comprising the injection of a gas mixture including a chlorinated compound and a carrier gas in a discharge or post-discharge area of a plasma.

Preferably, the chlorinated compound the does not comprise any oxygen atom, more preferably, the chlorinated compound does not comprise any hydrogen atom or any oxygen atom.

In order to avoid the degradation of the chlorinated precursor, and the oxidation of the growing chlorinated polymeric layer, the partial pressure of oxygen in the plasma device is preferably maintained below 10 hPa, advantageously below 5, even more preferably below 1 hPa. This may be achieved by using a purging procedure before initiating the deposition of the polymeric layer and/or by maintaining an oxygen-free gas flow as gaseous medium in which the plasma is generated. For example, the plasma reactor containing the gaseous medium in which the plasma is generated may be maintained at a pressure above atmospheric pressure for avoiding oxygen contamination from the atmosphere outside the plasma reactor and maintaining a rare gas flow for compensating gas leaks.

The chlorinated polymers such as PVC or PVDC presents a particular interest. Those polymers are particularly difficult to process using conventional method such as extrusion or coextrusion due to the unstability of the C—Cl chemical bond. At conventional extrusion temperature, large amount of chlorine can be emitted in the environment, degrading the properties of the final polymer, and representing a potential hazard for the health. This is particularly true for PVDC, strongly limiting its use. For that reason, PVDC is usually coated using solvent methods (emulsion or monophasic).

Nevertheless, PVDC thin coatings are quite useful in numerous industries. More specifically, its unique barrier properties render this polymer highly attractive for the packaging industry. Indeed, it is one of the few polymer having both high gas barrier properties and low water sensitivity.

Preferably, the precursor have a Cl/C atomic ratio higher than 0.25, more preferably higher than 0.5, advantageously higher than 0.75.

Surprisingly, the use of a precursor having a Cl/C ratio higher than 1 allows to obtain layers having properties close to those of pure PVDC. Advantageously, the precursor is a perchlorinated compound, or comprises a perchlorinated functional group such as a perchloroalkyl group.

Preferably, the precursor will be a polychlorinated organic compound selected from the group consisting of polychloroalkane, polychloroalkene, polychloroalkyne, polychlorobenzene and a tertiary amine comprising perchloroalkane functional groups. Said tertiary amine preferably has the following structure:

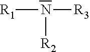

wherein R₁, R₂ et R₃ are selected from the group consisting of perchloroalkane, perchloroalkene, perchloroalkyne perchloroarene and combination thereof. The advantage of such a tertiary amine is a better control of the scission mechanisms of the precursor, inducing a better control of the aliphatic chains radicals length in the reactive medium. Long chains fragments being preferred, improving the deposited layer properties, perchlorotributylamine is a preferred precursor.

Advantageously, the precursor is liquid at room temperature and atmospheric pressure. Said precursor is preferably brought to the reactive medium by means of bubbling a carrier gas into the liquid precursor, thereby saturating said carrier gas by the precursor vapour. The precursor partial pressure can then be controlled by controlling the liquid precursor temperature. Said carrier gas would preferably be an inert gas such as a rare gas, preferably helium, argon, nitrogen or mixture thereof. In other words, the method of the invention preferably comprises the steps of:
bringing a carrier gas into contact with the liquid chlorinated compound;
saturating said carrier gas with vapor of said chlorinated compound in order to form a gas mixture;
bringing said gas mixture into the discharge area or in the post-discharge area of an atmospheric plasma;
placing a substrate in the discharge or post-discharge area of said atmospheric plasma.

As an alternative, the chlorinated precursor is injected directly in the plasma area or in the post plasma area, as liquid droplets, by means of a spray system.

The substrate can be placed either directly into contact to the plasma or in a post-plasma area. By post-plasma (post-discharge) area, it is meant in the present invention an area out of the plasma, located downstream of a plasma forming gas flow introduced in the plasma wherein reactive species such as radicals are still present. That post-plasma area is particularly useful for delicate substrate surfaces such as polymers. Preferably, the plasma forming gas is the same as the carrier gas, used for both carrying the polymeric precursor and producing the aerosol.

Direct plasma contact may also be advantageous, as it can induce an activation of the substrate surface and/or a cleaning by etching, thereby improving interfacial properties such as adhesion between the substrate and the polymeric layer.

The plasma used in the present invention will preferably be a cold plasma. The low temperature of the neutral and ionic species in such cold plasma allows reducing thermal degradation of the precursor, minimizing dechlorination in the case of chlorinated compounds, thereby improving the Cl/C ratio of the deposited layer.

By cold plasma, or non-thermal plasma, it is meant in the present invention a partially or wholly ionized gas comprising electrons, ions, atoms, molecules and radicals out of thermodynamic equilibrium characterized by an electron temperature significantly higher than the neutral and ionic species temperature. Preferably, in the present invention, the ionic and neutral temperature (i.e. macroscopic temperature) is lower than 400° C. Advantageously, said neutral and ionic species temperature is lower than 150° C., as at higher temperature, dechlorination of chlorinated species becomes noticeable. Ideally, the neutral and ionic species in the plasma is minimized, lower than 100° C. and/or close to room temperature.

The plasma is also preferably an atmospheric plasma. Advantageously having a pressure comprised between about 1 hPa and about 2000 hPa, preferably between 100 and 1200 hPa, ideally between 500 and 600 hPa, with other ranges obtainable by combining any above specified lower limits with any above specified upper limits being as if explicitly herein written out.

The process of the invention has the advantage to combine atmospheric plasma and liquid chlorinated monomer which is easier to store, to control and much less dangerous than the usual molecules.

Plasmas are usually used to decompose chlorinated compounds into the gas phase or to remove chlorine's contaminations from a surface and not to form a coating. This process allows to keep a ratio C/Cl in the deposited layer close to 1.

Most of existing chlorinated layers contain fluorine or silicon atoms. This invention has the ability to create coating composed only of carbon and chlorine atoms, with pattern closed to the structures of PVC or PVDC.

The deposition of a thin transparent layer can lead to modifications of properties of the surface of substrates. It is interesting for several markets as food and medicinal packaging.

### EXAMPLE 1

The precursor used in this example is hexachlorobuta-1,3-diene. It has a vapour pressure at room temperature of 0.3hPa. During the experiment, its temperature is maintained at 37° C. It was conveyed to the plasma rector by bubbling argon in the liquid precursor and transported through a tube. The argon flow was maintained at 121/min.

The plasma reactor was a DBD reactor. The working frequency was 15 kHz and the voltage was 1600V. The pressure was maintained between 400 et 415 Torr. The deposition time was 1 min. 30 sec. The air was first evacuated from the reactor down to a pressure of about 5 Torr before introducing the saturated gas carrier. The oxygen concentration in the air being around 20%, this means that the residual partial pressure of oxygen after this purging process is maintained below 1 Torr. The subsequent argon flow should further reduce this partial pressure.

The substrates used were stainless steel, PVC, silicon wafers and quartz. No difference between the different substrates has been found.

XPS measurements have shown that the deposited layers have Cl/C atomic ratios comprised between 0.9 and 1.1, very close to the PVDC theoretical value (1). The thickness of the deposited layers where estimated between 10 and 50 nm.

An additional experiment has been carried out at 660 Torr, using the same setup, the power being maintained at 30 W or 50 W.

The XPS spectrum of the coating is represented in FIG. 5. The measured Cl/C ratio was about 0.75.

### EXAMPLE 2

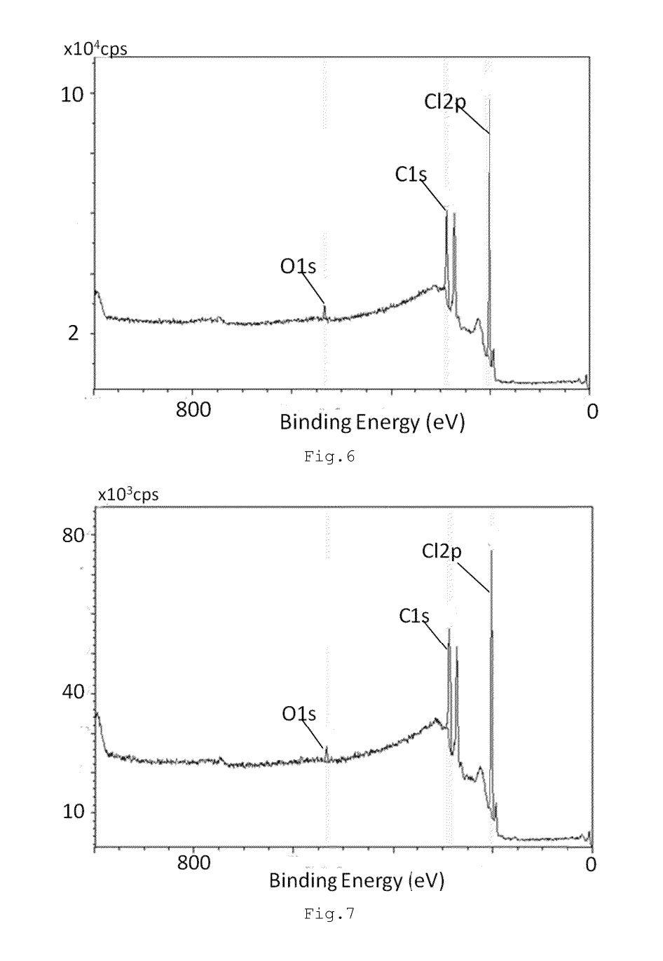

In the example 2, the following general procedure was used:
Cleaning the substrate using methanol and isooctane.
The electrode distance is fixed at 4 mm.
The reaction chamber is pumped down to a pressure of 1 torr Pumping is maintained during 2 min. A liquid nitrogen trap is used to avoid contamination from the pump.
Argon injection at the end of the pumping to a pressure of 750 torr. Let this at rest 2 min.
Ignite a plasma to activate the substrate.
Switch off the plasma and pump again down to 1 torr and maintain pumping 2 min.
Inject the mixture Argon+precursor and let it homogenise 2 min at target pressure.
Switch on the plasma, while maintaining an argon/precursor flow.
Switch off the plasma and restart the pumping procedure.
Inject Argon into the chamber up to atmospheric pressure.
   In example 2, hexachlorobuta-1,3-diene was used, and the parameters were the following:
Substrate inox
Initial Argon flow=8 L/min
Flow of the Argon-precursor mixture=3 L/min
T° 25° C.
Frequency=17.1 kHz
Power=60 W
Atmospheric pressure (760 torr)
Time of coating=10 minutes
Chemical composition: oxygen (2%), Carbone (46%), chlorine as measured by XPS (52%). XPS results are shown in FIG. 6.

### EXAMPLE 3

In the example 3, the same general procedure was used as in example 1, the precursor was 1,1,1,2-tetrachloroethane, the following parameters were used:
Substrate inox
Initial Argon flow=8 L/min
Flow of the Argon-precursor mixture=100 mL/min
T° 25° C.
Frequency=17.1 kHz
Power=80 W
Atmospherique pressure (760 torr)
Time of coating=6 minutes
Chemical composition: oxygen (2%), Carbone (53%), chlorine as measured by XPS (45%). XPS results are shown in FIG. 7.

1. Method for the deposition on a substrate of a chlorinated polymeric layer, said method comprising the steps of:
generating a plasma in a gaseous medium by means of a plasma device comprising optionally a post-plasma area said plasma device being maintained at a pressure comprised between 100 hPa and 2000 hPa;
placing the substrate in contact with the plasma, or in the post-plasma area;
introducing in said plasma or in the post-plasma area a precursor of the chlorinated polymer, said precursor comprising a chlorinated organic compound,
characterised in that the oxygen partial pressure in the plasma device is maintained below 10 hPa, preferably below 5 hPa.

2. Method according to claim 1 wherein the precursor partial pressure in the plasma device is lower than or equal to the saturation vapour pressure of the precursor at the substrate temperature.

3. Method according to claim 1 wherein the gaseous medium further comprises a plasma generating gas such as Argon or Helium.

4. Method according to claim 1 wherein the chlorinated precursor comprises a chlorinated organic compound having a Cl/C ratio higher than 0.25, preferably higher than 0.5, more preferably higher than or equal to 1.

5. Method according to claim 1 wherein said chlorinated precursor comprises a polychlorinated organic compound selected from the group consisting of polychloroalkane, polychloroalkene, polychloroalkyne, polychloroarene, tertiary amine comprising perchloroalkanes groups and mixture thereof.

6. Method according to claim 5 wherein said polychlorinated organic compound is a perchlorinated organic compound.

7. Method according to claim 5 wherein said chlorinated precursor comprises a compound having the following structure: 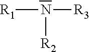
wherein R₁, R₂ et R₃ are selected from the group consisting of perchloroalkane, perchloroalkene, perchloroalkyne perchloroarene.

8. Method according to claim 1 wherein the temperature of ionic and neutral species in the plasma is below 400° C., preferably below 150° C.

9. Method according to any claim 1 wherein the plasma is a dielectric barrier discharge (DBD)plasma, a DC pulsed plasma, a microwave plasma or a electron cyclotron resonance (ECR) discharge plasmas.

10. Article comprising a substrate and a chlorinated polymeric layer producible by the method according to claim 1.

11. Article according to claim 10 wherein said polymeric layer is cross-linked.

12. Article according to claim 10 wherein said polymeric layer comprises a polymer selected from the group consisting of PVC, PVDC, polychloropropene, Poly(chloro-p-xylene), Poly(chlorotrifluoroethylene), Poly(vinyl chloroacetate), Poly(2-chlorostyrene) and mixture thereof.

13. Article according to claim 10 wherein the polymeric layer is a chlorinated polymer having a Cl/C ratio higher than or equal to 0.5.

14. Article according to claim 13, wherein the Cl/C ratio is higher than or equal to about 1.

15. Article according to claim 14, wherein the Cl/C ratio is comprised between 0.9 and 1.1.
